(19) United States
(12) Patent Application Publication
(10) Pub. No.: US 2023/0322432 A1
(43) Pub. Date: Oct. 12, 2023

(54) FOLDED PACKAGING CONTAINER STRUCTURE, DEVICE AND PROCESS

(71) Applicant: QINGDAO JKL PACKING CO., LTD., Jimo City (CN)

(72) Inventors: Shoudong WANG, Jimo City (CN); Tao YU, Jimo City (CN)

(21) Appl. No.: 18/132,515

(22) Filed: Apr. 10, 2023

(30) Foreign Application Priority Data
Apr. 10, 2022 (CN) 202210413662.6

(51) Int. Cl. B65D 5/20; B65D 5/24; B31B 50/60; B31B 50/28

(52) U.S. Cl. CPC B65D 5/208; B65D 5/244; B31B 50/60; B31B 50/28

(57) ABSTRACT

The present application relates to a folded packaging container structure, and a bottom folding-sealing device and process, including: a folded packaging body, which forms a cavity for accommodating a object after being folded; an upper opening, which is located on the folded packaging body, at which a cap is provided at least after the cavity is loaded with the object; a folded part A and a folded part B, which are folded and contacted with each other; a front surface of the folded part A and a front surface of the folded part B are provided as corresponding front surfaces of the folded packaging body and are located between the bottom part and the upper opening; at least a first side surface and a second side surface located between the bottom part and the upper opening are provided between the front surfaces.

### CROSS-REFERENCE TO RELATED APPLICATION

This application claims the priority and benefit of Chinese patent application serial no. 202210413662.6, filed on Apr. 10, 2022. The entirety of Chinese patent application serial no. 202210413662.6 is hereby incorporated by reference herein and made a part of this specification.

### TECHNICAL FIELD

The present application relates to a structure, folding-sealing device and process of a folded packaging container for a beverage.

### BACKGROUND ART

A folded packaging container, such as a composite paper (a pulp, an aluminum, or a tinfoil) and so on, is widely used in a packaging of a liquid (a water, a milk, a fruit juice, a liquid medicine and etc.) and etc., which includes at least two layers, and generally composed of multi layers. An inner wall layer has an anti-leakage material (such as a food grade plastic), and also has a property of being able to self melt and bond into a whole after being heated. However, composite paper materials at a middle or an outer side have a good shaping effect after being folded.

However, in existing technologies, after filling, one end needs to be sealed (usually at a bottom), and a side sealing part in the existing technologies is bonded after being folded sideways. Then, it is placed at another side (such as a bottom sealing part or a top sealing part) for contacting and bonding to be a whole.

In order to solve the above technical problems, currently, a PP/PE strip or an adhesive strips is used to bond after an inner surface and an outer surface of both sides are contacted, thus a hygiene and health of beverages is affected. An ear is formed by folding and is bonded, because a bottom connection part and a side connection part (also called as seam line, connecting line or sealing line) are located on a same vertical plane, which will cause the container to be deformed and sealed non-tightly, and cause a high reject rate due to a stress concentration and an existence of folded angles when it is turned over 90° sideways subsequently. Meanwhile, due to an existence of a middle sealing side, the container cannot stand stably, and the bottom part needs to be shaped to make a center of the bottom part concave, thus a process is complex.

### SUMMARY

In summary, a technical problem to be solved by the present application is how to provide a folded packaging container structure, a bottom folding-sealing device and a process.

In order to solve the above problem, technical solutions adopted by the present application are as follows.

A folded packaging container structure includes a folded packaging body, which forms a cavity for accommodating an object after being folded;
an upper opening, which is located on the folded packaging body, at which a cap is provided at least after the cavity is loaded with the object;
a bottom part, facing the upper opening;
a folded part A and a folded part B, which are folded and contacted with each other; a front surface of the folded part A and a front surface of the folded part B are provided as corresponding front surfaces of the folded packaging body and are located between the bottom part and the upper opening; at least a first side surface and a second side surface located between the bottom part and the upper opening are provided between the front surfaces;
the cavity is located among the bottom part, the upper opening, the folded part A, the folded part B, the first side surface and the second side surface.

As a further improvement of the above technical solutions:
at least one of the following solutions is included:
a) a first side sealing part and a second side sealing part are provided as sealing parts of side surfaces after the folded part A and the folded part B are folded together, and a bonding direction of the first side sealing part and an outer side of the first side surface is opposite to a bonding direction of the second side sealing part and an outer side of the second side surface;
b) when the first side sealing part is bonded to an outer wall of the folded part A, the second side sealing part is bonded to an outer wall of the folded part B;
c) a root of a bottom folded ear A is connected with a lower part of the front surface of the folded part A, and there is a crease line CD at a connection part; a root of a bottom folded ear B is connected with a lower part of the front surface of the folded part B, and there is a first crease line parallel to the crease line CD at the connection part;
d) a bottom sealing part is provided as a sealing part of a bottom surface after the folded part A and the folded part B are folded; the bottom sealing part and the first side sealing part are not coplanar and/or the bottom sealing part and the second side sealing part are not coplanar;
e) at the first side surface, there is a formed concavity A between an inner wall of the folded part A and the folded part B; at the second side surface, there is a formed concavity B that is stagger with the formed concavity A between the inner wall of the folded part A and the folded part B;
f) a joint surface of the bottom sealing part is perpendicular to a joint surface of the first side sealing part and/or a joint surface of the second side sealing part;
g) a cap is provided at the upper opening at least after the cavity is loaded with the object;
h) a sealing treatment of the first side sealing part and that of the second side sealing part are performed simultaneously or respectively.

The crease line CD and the first crease line are edge lines of the bottom part;
the first upper folded ear is located at an upper part of the first side surface, and a second top folded ear is located at an upper part of the second side surface; when the folded packaging body is in an unfolded state, the crease line CD is perpendicular or oblique to a crease line VW of a root of the first upper folded ear or a crease line XY of a root of the second top folded ear respectively, and the first crease line is perpendicular or oblique to the crease line VW of the root of the first upper folded ear or the crease line XY of the root the second top folded ear respectively.
the folded part A and/or the folded part B includes: the front surface;
a first side surface part, one side of which is connected with one side of the front surface through a crease line WC, and which is located at the first side surface after being folded;
a second side surface par, one side of which is connected with the other side of the front surface through a crease line YD, and which is located at the second side surface after being folded;
a first connecting part, one side of which is connected with one side of the first side surface part;
a second connecting part, one side of which is connected with one side of the second side surface part;
the first connecting part of the folded part A and the first connecting part of the folded part B are sealingly bonded together to form the first side sealing part, and the second connecting part of the folded part A and the second connecting part of the folded part B are sealingly bonded together to form the second side sealing part;
a first folded surface of bottom folded ear, which is connected with one side waist of the bottom folded ear A through a crease line CG and is located at the bottom part after being folded;
a first bottom surface, which is connected with the first side surface part through a crease line BC and connected with the first folded surface of bottom folded ear through a crease line CI, and is located at the bottom part after being folded; after being folded, the first folded surface of bottom folded ear is located between the bottom folded ear A and the first bottom surface;
a second folded surface of bottom folded ear, which is connected with the other waist of the bottom folded ear A through a crease line DG and is located at the bottom part after being folded;
a second bottom surface, which is connected with the second side surface part through a crease line DE and connected with the second folded surface of bottom folded ear through a crease line DK, and is located at the bottom part after being folded; after being folded, the second folded surface of bottom folded ear is located between the bottom folded ear A and the second bottom surface;
a first direction changing side sealing part I, which is connected with the first connecting part through a crease line AB and connected with the first bottom surface through a crease line BH, and is located at the bottom part after being folded; after being folded, the first direction changing side sealing part I of the folded part A and the first direction changing side sealing part I of the folded part B are bonded together to form one part of the bottom sealing part;
a second direction changing side sealing part I, which is connected with the second connecting part through a crease line EF and connected with the second bottom surface through a crease line EL, and is located at the bottom part after being folded; after being folded, the second direction changing side sealing part I of the folded part A and the second direction changing side sealing part I of the folded part B are bonded together to form one part of the bottom sealing part;
a first direction re-changing side sealing part II, which is connected with the first direction changing side sealing part I through a crease line GH; after being folded, the first direction re-changing side sealing part II of the folded part A and the first direction re-changing side sealing part II of the folded part B are bonded together to form a first connection part with the first side sealing part;
a second direction re-changing side sealing part II, which is connected with the second direction changing side sealing part I through a crease line LM; after being folded, the second side sealing part II of the folded part A and the second side sealing part II of the folded part B are bonded together to form a second connection part with the second side sealing part;
the formed concavity A corresponds to the first connection part, and the formed concavity B corresponds to the second connection part;
a first bottom sealing part I, which is connected with the first folded surface of bottom folded ear through a crease line IG; a second bottom sealing part I, which is connected with the second folded surface of bottom folded ear through a crease line KG; the first bottom sealing part I and the second bottom sealing part I of the bottom folded ear A and the bottom folded ear
B respectively are connected through a crease line GR, and contacted with each other and sealingly bonded together;
a first bottom sealing part II, which is connected with the first bottom sealing part I through a crease line IQ, connected with the first bottom surface through a crease line HI, and connected with the first direction re-changing side sealing part II through a crease line HP;
a second bottom sealing part II, which is connected with the second bottom sealing part I through a crease line KS, connected with the second bottom surface through a crease line KL, and connected with the second direction re-changing side sealing part II through a crease line LT; the first bottom sealing part II and the second bottom sealing part II of the bottom folded ear A and the bottom folded ear B respectively are contacted with each other and sealingly bonded together.

A bottom folding-sealing device is configured for a bottom sealing of a folded packaging container structure according to claim 1,
including at least one of the following process stations:
a side sealing surface folding station, configured for folding and/or bonding the first side sealing part and the outer side of the first side surface, and folding and/or bonding the second side sealing part and the outer side of the second side surface, by using a mold; a bonding direction of the first side sealing part and the outer side of the first side surface is opposite to that of the second side sealing part and the outer side of the second side surface;
a filling station, in which a filling is performed from a bottom opening to be sealed of the folded packaging body by using a filling machine;
a bottom surface folding station, in which the bottom sealing part is formed by folding the bottom part;
a bottom sealing station, in which the bottom sealing part is sealed by using a bottom sealing bonding head;
a bottom sealing part side folding station, configured for folding a sealed bottom sealing part sideways by 90°;
a bottom folded ear folding station, configured for folding the bottom folded ear A and the bottom folded ear B;
a bottom bonding station, configured for bonding the bottom folded ear A to the bottom part;
a bottom sealing part side bonding station, configured for bonding the bottom sealing part to the bottom part;
a station connection device, provided between stations.

As the further improvement of the above technical solutions:
the side sealing surface folding station is provided with a side folding bottom mold, which is provided with a side folding center hole corresponding to a cap; the side folding bottom mold is provided with a side folding outer mold for folding, which is connected with a side folding driving rod; the side folding outer mold is U-shaped, a middle side folding concave thereof corresponds to a front surface; one end of the side folding outer mold is provided with a side folding process end surface, and the other end is provided with a side folding L-shape step;
the side folding process end surface corresponds to a lateral edge of the second side sealing part or the first side sealing part, and the side folding L-shape step corresponds to an outer surface of the first side sealing part or the second side sealing part;
an inner forming mandrel mold is inserted in the bottom opening to be sealed of the folded packaging body, and a side folding pushing-up head configured for pushing up is provided under the side folding center hole;
a bonding is performed by using a mold, the first side sealing part and the outer side of the first side surface are bonded, and the second side sealing part and the outer side of the second side surface are bonded; the bonding direction of the first side sealing part and the outer side of the first side surface is opposite to that of the second side sealing part and the outer side of the second side surface;
an upper part of the bottom surface folding station is provided with a bottom sealing folding lifting guide, a lower end thereof is connected with a bottom sealing folding guide spring piece, which is “ [symbol] ” shaped and prevents the folded part A and the folded part B from being folded inwards; an outer side of the folded part A and the folded part B is provided with a bottom sealing folding end surface side step configured for supporting the folded part A and the folded part B; an outer side of the first side surface and the second side surface is provided with a bottom sealing side swing pressing mold block configured for changing the first bottom surface and the second bottom surface from vertical to horizontal;
at the bottom sealing station, a bottom sealing part is sealed by using a bottom sealing bonding head;
the bottom sealing part side folding station folds a sealed bottom sealing part sideways by 90°;
the bottom folded ear folding station folds the bottom folded ear A and the bottom folded ear B;
the bottom bonding station bonds the bottom folded ear A to the bottom part;
the bottom sealing part side bonding station bonds the bottom sealing part to the bottom part.
the station connection device includes a linear reciprocating mold or a circulating conveyor belt; the linear reciprocating mold or the circulating conveyor belt is provided with a station connection process opening; a molding mold outside the station corresponding to a contour of the folded packaging body is provided on the station connection process opening, and a pushing rod at station configured for pushing the cap up is provided under the station connection process opening;
the molding mold outside the station is provided with a station process concavity corresponding to the second top folded ear or the first upper folded ear;
at the bottom sealing station, an outer side of the first side surface and the second side surface is provided with a pair of swingable bottom sealing bonding side pressing mold blocks, which respectively presses downwards the folded first bottom surface and the folded second bottom surface;
an outer side of the folded part A and the folded part B is provided with a bottom sealing molding end surface step configured for supporting the bottom folded ear A and the bottom folded ear B; an upper part of the bottom sealing molding end surface step is provided with a bottom sealing folding pressing mold, which is configured for pressing the bottom folded ear A and the bottom folded ear B located on the bottom sealing molding end surface step after going down;
the bottom sealing bonding head is provided with a bottom sealing bonding lifting head;
the bottom sealing part side folding station is provided with a bottom sealing side pressing mold that can swing, rotate or be lifted, which is configured for folding the sealed bottom sealing part sideways by 90°;
the bottom folded ear folding station is provided with a bottom sealing folded ear end surface pushing mold that is fixed, rotatable, retractable or can swing, which is configured for pressure contacting with the outer surface of the front surface; an upper part of the bottom sealing folded ear end surface pushing mold is provided with a swingable bottom sealing folded ear mold configured for folding the corresponding bottom folded ear A and the bottom folded ear B;
the bottom bonding station is provided with a bottom sealing folded ear bonding head configured for bonding the bottom folded ear A and the bottom folded ear B to the bottom part.

A bottom folding-sealing process is configured for a bottom sealing of the folded packaging container structure according to claim 1,
including at least the following steps:
Step 1 simultaneously or successively sealing both side sealing parts, a first side sealing part and a second side sealing part are heated, bonded and sealed respectively;
Step 3 folding a bottom sealing side, a bottom part is folded along crease lines by using a mold or manual to connect the bottom sealing part; in particular, a joint surface of the bottom sealing part is perpendicular to the joint surface of the first side sealing part;
Step 4 sealing the bottom sealing side, the bottom sealing part is heated, bonded and sealed.

As the further improvement of the above technical solutions:
in Step 1, when sealing the first side sealing part, a first direction re-changing side sealing part II of a folded part A and a first direction re-changing side sealing part II of a folded part B are bonded together to form a first connection part with the first side sealing part;
when sealing the second side sealing part, a second direction re-changing side sealing part II of a folded part A and a second direction re-changing side sealing part II of the folded part B are bonded together to form a second connection part with the second side sealing part;
Step 2 folding the side sealing parts,
when folding the side sealing part, by using the mode or manual, the first side sealing part is folded towards the outer side of the second side surface, and the second side sealing part is folded towards the outer side of the second side surface; a folding direction of the first side sealing part is the same as or opposite to that of the second side sealing part;
there are also the following steps before or after Step 1: a first side surface and a second side surface are folded, when folding the first side surface and the second side surface, one side of a first side surface part is connected with one side of a front surface through a crease line WC, and the first side surface part is located at the first side surface after being folded; one side of a second side surface part is connected with the other side of the front surface through a crease line YD, and the second side surface part is located at the second side surface after being folded;
Step 5 folding the bottom sealing side sideways: the bottom sealing part is folded sideways by using the mold or manual;
after Step 5, first, a first upper folded ear and a second top folded ear is folded by using the mold or manual and then contacted with the bottom sealing part; then, bonding the bottom folded ear is performed, the first upper folded ear and the second top folded ear respectively are bonded to the bottom sealing part by using a welding machine, a bonding machine or a hot air blower;
after Step 2, a side bonding is performed, by using the mode, the first side sealing part and the outer side of the second side surface are bonded together, and the second side sealing part and the outer side of the second side surface are bonded together; a bonding direction of the first side sealing part and the outer side of the first side surface is the same as or opposite to that of the second side sealing part and the outer side of the second side surface;
after Step 2, a filling is performed from a bottom opening to be sealed of the folded packaging body by using a filling machine;
after Step 2 or Step 1, and before Step 3, the bottom folded ear A and the bottom folded ear B are folded for a preforming of the bottom part, so that the crease lines of the bottom part generates a crease memory.

In Step 3, folding the bottom sealing side includes that:
a first direction changing side sealing part I, a first bottom surface, a first folded surface of bottom folded ear, a second folded surface of bottom folded ear, a second bottom surface and a second direction changing side sealing part I are folded along crease line AB, BC, CG, DG, DE and EF respectively;
the first direction re-changing side sealing part II, a first bottom sealing part II, a first bottom sealing part I, a second bottom sealing part I, a second bottom sealing part II and the second direction re-changing side sealing part II are folded along crease line GH, HI, IG, GK, KL and LM respectively, so that the first bottom sealing part II is contacted with the second bottom sealing part II, and the first bottom sealing part I is contacted with the second bottom sealing part I;
when the first direction re-changing side sealing part II and the second direction re-changing side sealing part II are folded towards same direction, a formed concavity A and a formed concavity B at both sides are contacted with each other; when the first direction re-changing side sealing part II and the second direction re-changing side sealing part II are folded towards opposite direction, a protrusion formed by folding the first direction re-changing side sealing part II is contacted with the formed concavity B formed by folding the second direction re-changing side sealing part II, and a protrusion formed by folding the second direction re-changing side sealing part II is contacted with the formed concavity A formed by folding the first direction re-changing side sealing part II;
for Step 4 sealing the bottom sealing side, the bottom sealing part is heated, bonded and sealed;
after Step 5, the bottom folded ear A is folded along a crease line CD.

The present application has a reasonable design and a low cost, is durable, safe and reliable. An operation thereof is simple, which can save time, labor and money, a structure is compact and a use is convenient.

### BRIEF DESCRIPTION OF THE DRAWINGS

FIG. 1 is a diagram of a structure of prior art 1 of the present application.

FIG. 2 is a diagram of a structure of prior art 2 of the present application.

FIG. 3 is a diagram of a structure of a first improvement in the present application.

FIG. 4 illustrates a structure of a composite paper in an unfolded state in the present application.

FIG. 5 illustrates a structure of the composite paper in the present application.

FIG. 6 illustrates a structure of the composite paper before folding in the present application.

FIG. 7 is a block diagram of a composite paper process route in Embodiment 1 of the present application.

FIG. 8 is a block diagram of a composite paper process route in Embodiment 2 of the present application.

FIG. 9 is a block diagram of a composite paper process route in Embodiment 3 of the present application.

FIG. 10 is a block diagram of a composite paper process route in Embodiment 4 of the present application.

FIG. 11 is a block diagram of a composite paper process route in Embodiment 5 of the present application.

FIG. 12 is a diagram of a composite paper process route in the present application.

FIG. 13 is a diagram of a side sealing part in embodiment 1 of the present application.

FIG. 14 is a diagram of a structure of a side sealing part in embodiment 2 of the present application.

FIG. 15 is a diagram of a structure of a bottom sealing part in embodiment 1 of the present application.

FIG. 16 is a diagram of a structure of a bottom sealing part in embodiment 2 of the present application.

### DETAILED DESCRIPTION

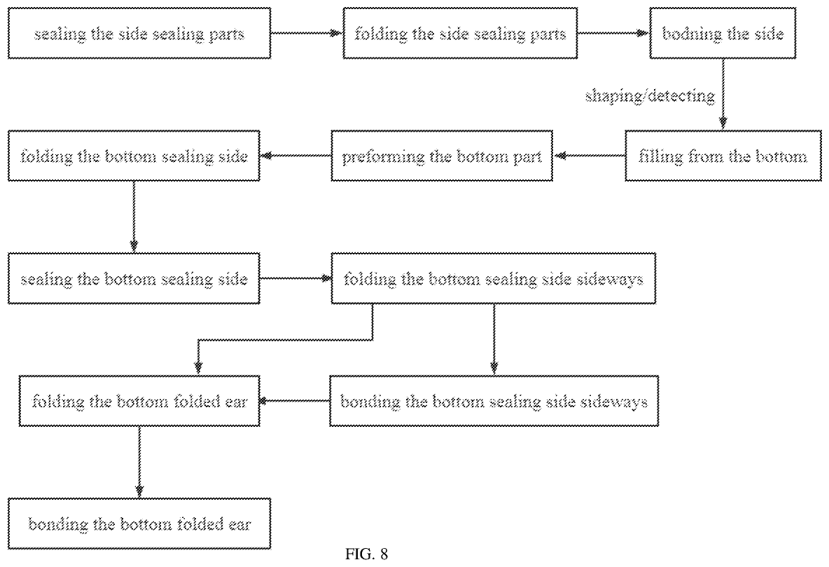

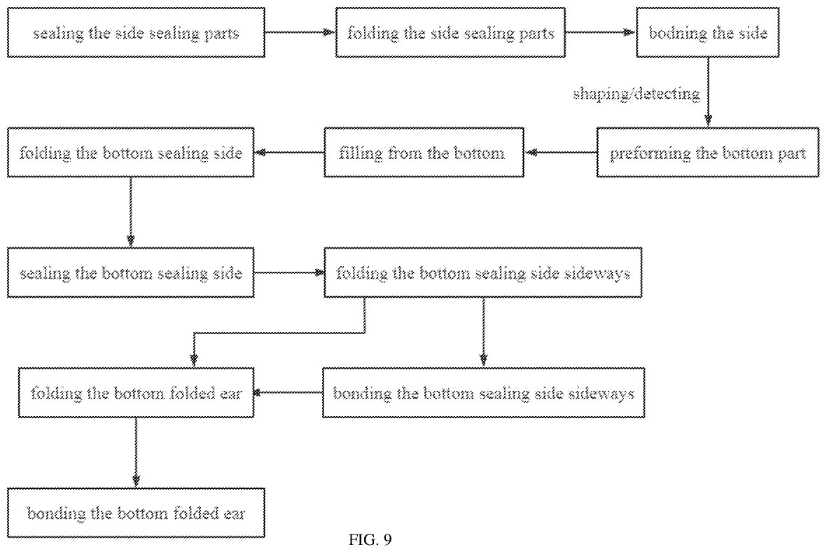

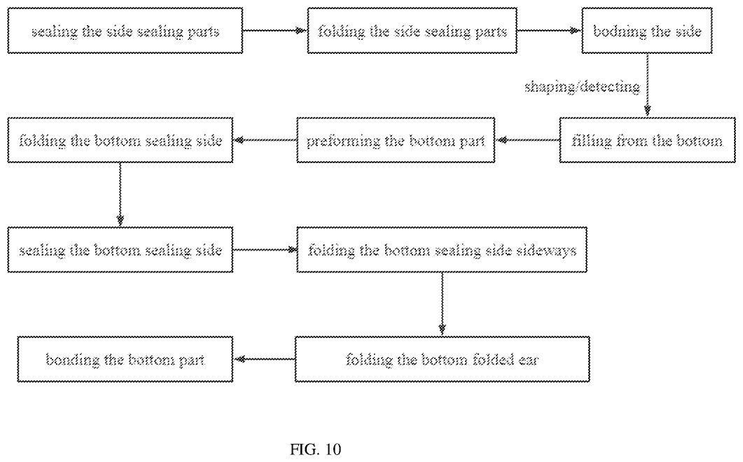

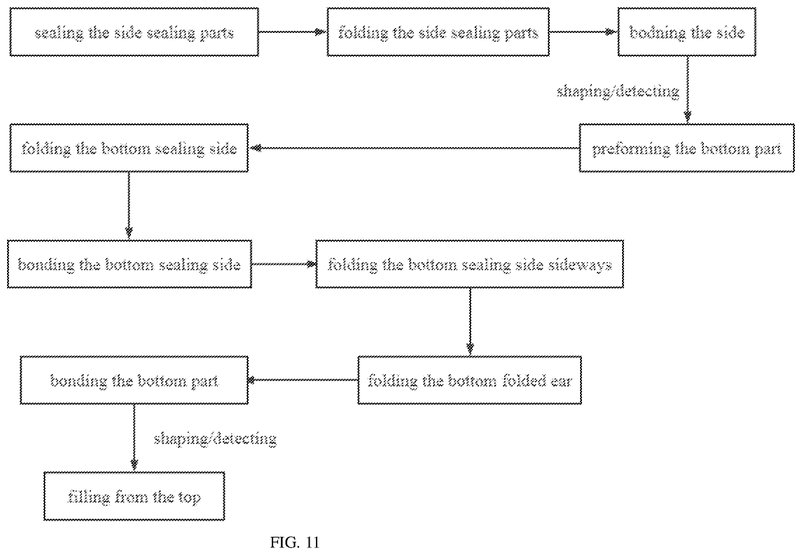

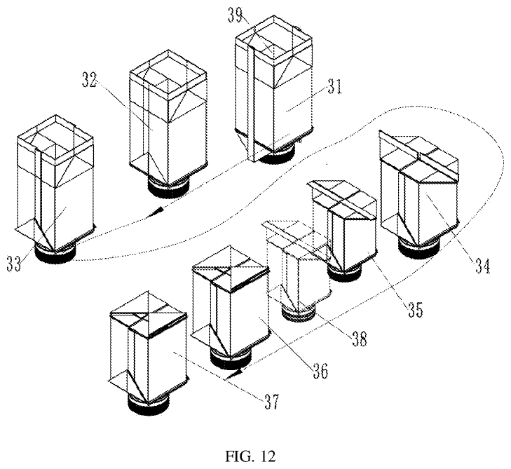

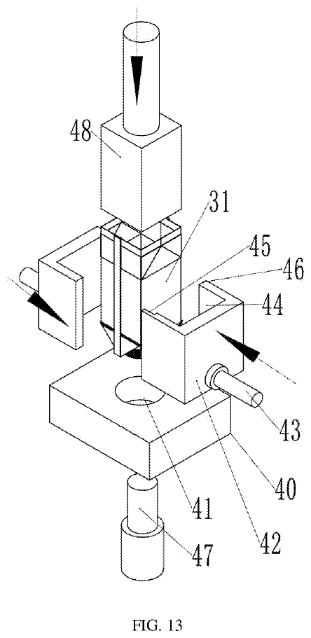

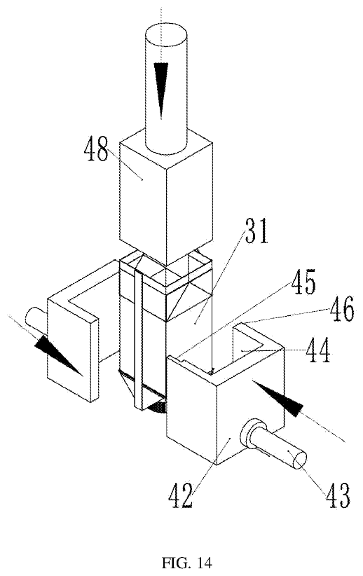

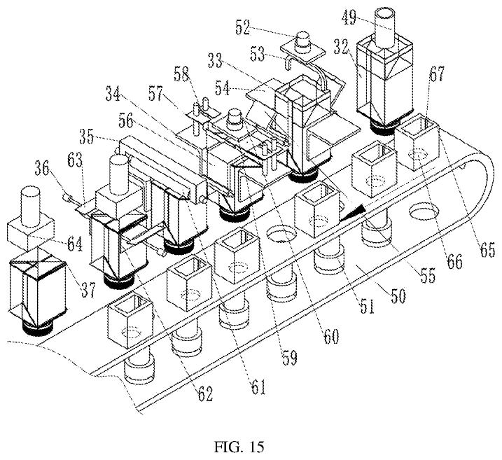

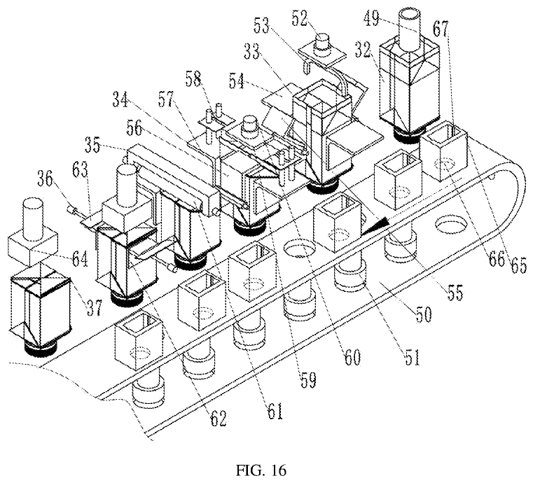

As shown in FIGS. 1-16, a folded packaging container structure in the present application includes a folded packaging body 1, which forms a cavity for accommodating a object after being folded. The load generally is a liquid, but a particle or a solid is also within a protection scope of the present application.

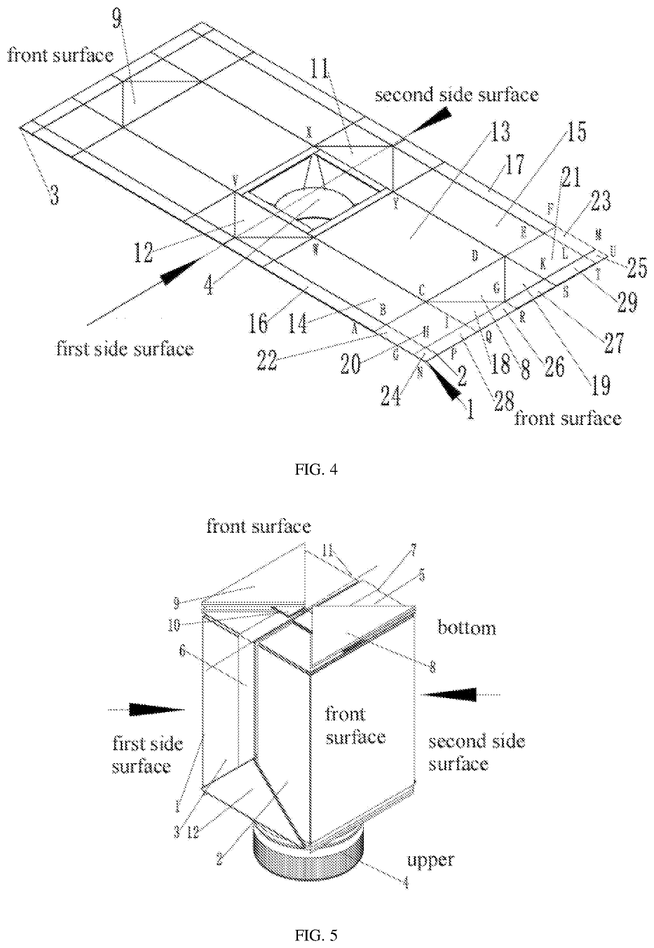

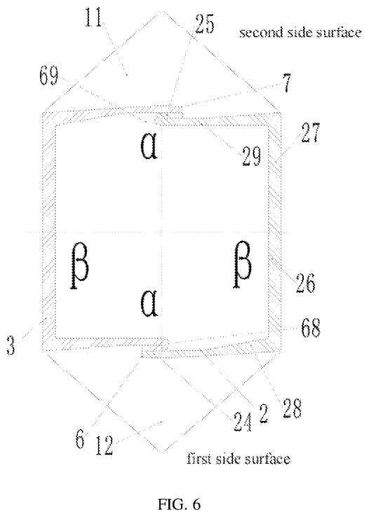

In particular, as shown in FIGS. 4 and 5, an upper opening is located on the folded packaging body 1, and a cap 4 is provided at the upper opening at least after the cavity is loaded with the object (for example, is filled with the liquid or stores the solid). Generally, the cap 4 is mounted preferably before filling the liquid to avoid a secondary pollution. For a container corresponding to the upper opening, such as a paper cup, the cap 4 does not need to be mounted or can be mounted according to a demand. If the upper opening is changed to a side opening or a bottom opening, which is also within the protection scope of the present invention. If the upper opening is sealed by other means (such as sticking a film, pasting or folding), however, after cutting an upper part of the cavity for accommodating the object, the upper opening still will be exposed, which is also within the protection scope. As the protection scope of the present application, if the opening at a side or a front (back) is used as the side opening to avoid the upper opening, which is also equivalent to the present application. Exchanging a bottom part and an upper part of the present application, or exchanging an placement method, is the protection scope. Moreover, any surface can be changed to a plane or a three-dimensional shape, which is within the protection scope.

As shown in FIGS. 5 and 6, a second top folded ear 11 is located at a second side surface.

The bottom part 5 faces the upper opening, and has a function of supporting the container as a bottom.

A folded part A 2 and a folded part B 3 are folded and contacted with each other; a front surface 13 of the folded part A 2 and a front surface 13 of the folded part B 3 are provided as corresponding front surfaces of the folded packaging body 1 (it can also be considered as a front surface and a back surface), and are located between the bottom part 5 and the upper opening. At least a first side surface and the second side surface located between the bottom part and the upper opening are provided between the front surfaces.
the cavity is located among the bottom part 5, the upper opening, the folded part A 2, the folded part B 3, the first side surface and the second side surface. That is, the cavity is a quadrangular prism structure preferably, but not limited to the quadrangular prism structure, such as a polygon prism or other container structure with at least upper and lower parts and four side surfaces.

In the present application, a folded line and a crease line have a same meaning, and can be a continuous line or a broken line. The folded line can be an extension virtual line of a corresponding surface, which is visible or invisible to a naked eye. The line can be a multi branched polyline with common endpoints, and can be a reasonably deformed curves, etc.

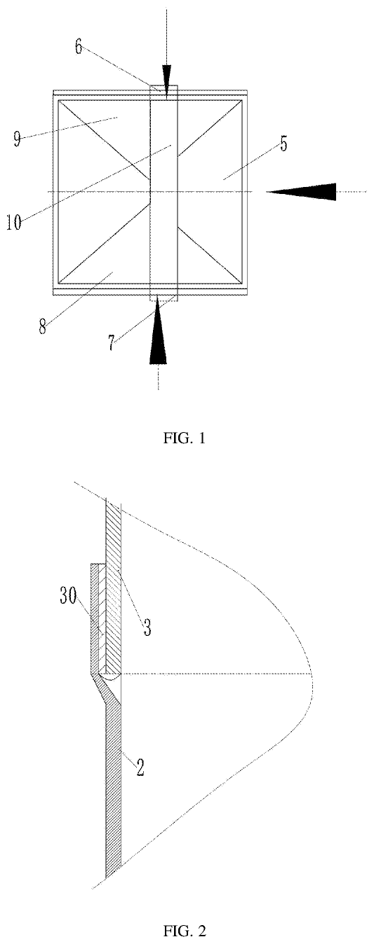

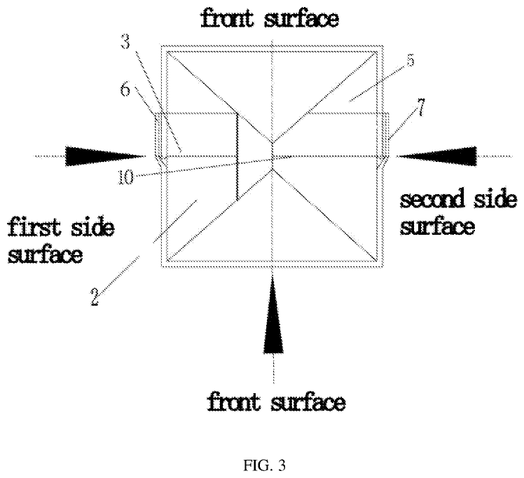

The present application includes at least one of the following solutions or reasonable combinations thereof.
a) as shown in FIGS. 4-5, a first side sealing part 6 and a second side sealing part 7 are provided as sealing parts of side surfaces after the folded part A 2 and the folded part B 3 are folded together, and a bonding direction of the first side sealing part 6 and an outer side of the first side surface is opposite to a bonding direction of the second side sealing part 7 and an outer side of the second side surface, which is an important invention point of the present application, and solves technical problems existing in a traditional folding method as shown in FIG. 1 and existing before an improvement of the present application as shown in FIG. 2. For example, the bottom is not tightly sealed, a welding process at an intersection is poor, and a stress is unbalanced, so that a shape of the container is prone to deformation. As shown in FIG. 1, sealing part are all coplanar, a leakage is prone to occur, and a placement and a stacking are inconvenient and unstable. An adhesive strip 30 is removed, which makes it safer and more hygienic, achieves a direct sealing, and reduces a size of the container, so that the container is more regular. However, if the adhesive strip 30 is added to avoid the present application, which is within the protection scope of the present application.

When the first direction re-changing side sealing part II 24 and the second direction re-changing side sealing part II 25 are folded towards same direction, a formed concavity A 68 and a formed concavity B 69 at both sides are contacted with each other. When the first direction re-changing side sealing part II 24 and the second direction re-changing side sealing part II 25 are folded towards opposite direction, a protrusion formed by folding the first direction re-changing side sealing part II 24 is contacted with the formed concavity B 69 formed by folding the second direction re-changing side sealing part II 25, and a protrusion formed by folding the second direction re-changing side sealing part II 25 is contacted with the formed concavity A 68 formed by folding the first direction re-changing side sealing part II 24.
b) When the first side sealing part 6 is bonded to an outer wall of the folded part A 2, the second side sealing part 7 is bonded to an outer wall of the folded part B 3. This is a description of solution a).
c) A root of a bottom folded ear A 8 is connected with a lower part of the front surface 13 of the folded part A 2, and there is a crease line CD at a connection part; a root of a bottom folded ear B 9 is connected with a lower part of the front surface 13 of the folded part B, and there is a first crease line parallel to the crease line CD at the connection part. Therefore a bottom folding is achieved.
d) a bottom sealing part 10 is provided as a sealing part of a bottom surface after the folded part A 2 and the folded part B 3 are folded; the bottom sealing part 10 and the first side sealing part 6 are not coplanar and/or the bottom sealing part 10 and the second side sealing part 7 are not coplanar. As another major invention point of the present application, it solves the problem of mutual interference between the bottom folded ear existing in the solution as shown in FIG. 1, and the stress is more reasonable and the forming is more stable.
e) at the first side surface, there is the formed concavity A 68 between an inner wall of the folded part A 2 and the folded part B 3; at the second side surface, there is the formed concavity B 69 that is stagger with the formed concavity A 68 between the inner wall of the folded part A 2 and the folded part B 3. As another major invention point of the present application, when sealing the bottom part, a mutual adaptation is achieved, so that the present application has a better sealing performance, good processability, uniform thickness and regular appearance.
f) in a direction of projection from the first side surface to the second side surface, a joint surface of the bottom sealing part 10 is perpendicular to a joint surface of the first side sealing part 6 and/or a joint surface of the second side sealing part 7. Moreover, as shown in the drawings, the two are not collinear.

The crease line CD and the first crease line are edge lines of the bottom part 5.

The bottom folded ear A 8 and a first upper folded ear 12 are an isosceles triangle or an isosceles trapezoid.

The first upper folded ear 12 is located at an upper part of the first side surface, and a second top folded ear 12 is located at an upper part of the second side surface; when the folded packaging body 1 is in an unfolded state, the crease line CD is perpendicular or oblique to a crease line VW of a root of the first upper folded ear 12 or a crease line XY of a root of the second top folded ear 11 respectively (preferably vertical), and the first crease line is perpendicular or oblique to the crease line VW of the root of the first upper folded ear 12 or the crease line XY of the root the second top folded ear 11 respectively. As another major invention point of the present application, when sealing the bottom part, the mutual adaptation is achieved, so that the present application has a better sealing performance, good processability, uniform thickness and regular appearance.

As shown in FIG. 4, as an embodiment, the folded part A 2 and/or the folded part B 3 includes: the front surface 13;
a first side surface part 14, one side of which is connected with one side of the front surface 13 through a crease line WC, and which is located at the first side surface after being folded;
a second side surface part 15, one side of which is connected with the other side of the front surface 13 through a crease line YD, and which is located at the second side surface after being folded;
a first connecting part 16, one side of which is connected with one side of the first side surface part 14;
a second connecting part 17, one side of which is connected with one side of the second side surface part 15;
the first connecting part 16 of the folded part A 2 and the first connecting part 16 of the folded part B 3 are sealingly bonded together to form the first side sealing part 6, and the second connecting part 17 of the folded part A 2 and the second connecting part 17 of the folded part B 3 are sealingly bonded together to form the second side sealing part 7;
a first folded surface of bottom folded ear 18, which is connected with one side waist of the bottom folded ear A 8 through a crease line CG and is located at the bottom part 5 after being folded;
a first bottom surface 20, which is connected with the first side surface part 14 through a crease line BC and connected with the first folded surface of bottom folded ear 18 through a crease line CI, and is located at the bottom part 5 after being folded; after being folded, the first folded surface of bottom folded ear 18 is located between the bottom folded ear A 8 and the first bottom surface 20;
a second folded surface of bottom folded ear 19, which is connected with the other side waist of the bottom folded ear A 8 through a crease line DG and is located at the bottom part 5 after being folded;
a second bottom surface 21, which is connected with the second side surface part 15 through a crease line DE and connected with the second folded surface of bottom folded ear 19 through a crease line DK, and is located at the bottom part 5 after being folded; after being folded, the second folded surface of bottom folded ear 19 is located between the bottom folded ear A 8 and the second bottom surface 21;
a first direction changing side sealing part I 22, which is connected with the first connecting part 16 through a crease line AB and connected with the first bottom surface 20 through a crease line BH, and is located at the bottom part 5 after being folded; after being folded, the first direction changing side sealing part I 22 of the folded part A 2 and the first direction changing side sealing part I 22 of the folded part B 3 are bonded together to form one part of the bottom sealing part 10;
a second direction changing side sealing part I 23, which is connected with the second connecting part 17 through a crease line EF and connected with the second bottom surface 21 through a crease line EL, and is located at the bottom part 5 after being folded; after being folded, the second direction changing side sealing part I 23 of the folded part A 2 and the second direction changing side sealing part I 23 of the folded part B 3 are bonded together to form one part of the bottom sealing part 10;
a first direction re-changing side sealing part II 24, which is connected with the first direction changing side sealing part I 22 through a crease line GH; after being folded, the first direction re-changing side sealing part II 24 of the folded part A 2 and the first direction re-changing side sealing part II 24 of the folded part B 3 are bonded together to form a first connection part with the first side sealing part 6;
a second direction re-changing side sealing part II 25, which is connected with the second direction changing side sealing part I 23 through a crease line LM; after being folded, the second direction re-changing side sealing part II 25 of the folded part A 2 and the second direction re-changing side sealing part II 25 of the folded part B 3 are bonded together to form a second connection part with the second side sealing part 7;
the formed concavity A 68 corresponds to the first connection part, and the formed concavity B 69 corresponds to the second connection part, so as to achieve a good adhesion, good sealing performance, a feature that is not easy deformed, and reasonable structure.

As the embodiment, a first bottom sealing part I 26 is connected with the first folded surface of bottom folded ear 18 through a crease line IG; a second bottom sealing part I 27 is connected with the second folded surface of bottom folded ear 19 through a crease line KG; the first bottom sealing part I 26 and the second bottom sealing part I 27 of the bottom folded ear A 2 and the bottom folded ear B 9 respectively are connected through a crease line GR, and contacted with each other and sealingly bonded together;
a first bottom sealing part II 28 is connected with the first bottom sealing part I 26 through a crease line IQ, connected with the first bottom surface 20 through a crease line HI, and connected with the first direction re-changing side sealing part II 24 through a crease line HP;
a second bottom sealing part II 29 is connected with the second bottom sealing part I 27 through a crease line KS, connected with the second bottom surface 21 through a crease line KL, and connected with the second direction re-changing side sealing part II 25 through a crease line LT; the first bottom sealing part II 28 and the second bottom sealing part II 29 of the bottom folded ear A 2 and the bottom folded ear B 9 respectively are contacted with each other and sealingly bonded together. Thus, the good adhesion is achieved, the structure is reasonable and beautiful, a cross shaped adhesive structure is achieved, each surface is not easily deformed, and the stress is balanced.

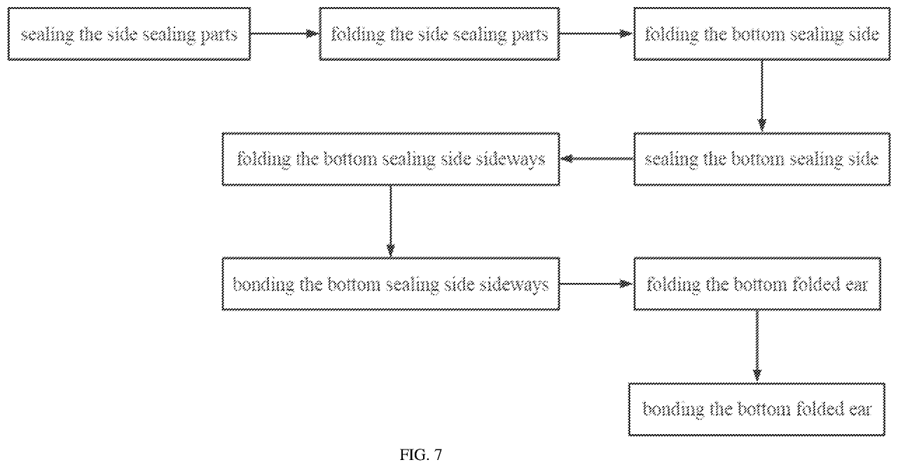

As shown in FIGS. 7-16, the bottom folding-sealing device of the embodiment is preferably configured for a bottom sealing of the folded packaging container structure, and includes at least one of the following process stations of the embodiment:
a side sealing surface folding station 31, configured for folding and/or bonding the first side sealing part 6 and the outer side of the first side surface, and folding and/or bonding the second side sealing part 7 and the outer side of the second side surface, by using a mold; the bonding direction of the first side sealing part 6 and the outer side of the first side surface is opposite to the bonding direction of the second side sealing part 7 and the outer side of the second side surface;
a filling station 32, in which a filling is performed from a bottom opening to be sealed 39 of the folded packaging body 1 by using a filling machine 49;
a bottom surface folding station 33, in which the bottom sealing part 10 is formed by folding the bottom part 5;
a bottom sealing station 34, in which the bottom sealing part 10 is sealed by using a bottom sealing bonding head 59;
a bottom sealing part side folding station 35, configured for folding a sealed bottom sealing part 10 sideways by 90°;
a bottom folded ear folding station 36, configured for folding the bottom folded ear A 8 and the bottom folded ear B 9;
a bottom bonding station 37, configured for bonding the bottom folded ear A 8 to the bottom part 5;
a bottom sealing part side bonding station 38, configured for bonding the bottom sealing part 10 to the bottom part 5;
a station connection device 50 provided between stations, which can be a general mechanism such as a manipulator or a conveyor belt, and a reasonable adaptive improvement thereof. The main station is described herein, but other auxiliary stations are not shown, which is a common knowledge.

As the embodiment, the side sealing surface folding station 31 is provided with a side folding bottom mold 40, which is provided with a side folding center hole 41 corresponding to a cap 4, so as to achieve a positioning; the side folding bottom mold 40 is provided with a side folding outer mold 42 for folding, which is connected with a side folding driving rod 43; the side folding outer mold 42 is U-shaped, a middle side folding concave 44 thereof corresponds to a front surface 13; one end of the side folding outer mold 42 is provided with a side folding process end surface 46, and the other end is provided with a side folding L-shape step 45; thus achieving profiling, internal support, external extrusion, and bottom support to achieve positioning and folding extrusion.

As an embodiment, the side folding process end surface 46 corresponds to a lateral edge of the second side sealing part 7 or the first side sealing part 6, and the side folding L-shape step 45 corresponds to an outer surface of the first side sealing part 6 or the second side sealing part 7;
an inner forming mandrel mold 48 is inserted in the bottom opening to be sealed 39 of the folded packaging body 1, and a side folding pushing-up head 47 configured for pushing up is provided under the side folding center hole 41;
a bonding is performed by using a mold, the first side sealing part 6 and the outer side of the first side surface are bonded, and the second side sealing part 7 and the outer side of the second side surface are bonded; the bonding direction of the first side sealing part 6 and the outer side of the first side surface is opposite to that of the second side sealing part 7 and the outer side of the second side surface;
an upper part of the bottom surface folding station 33 is provided with a bottom sealing folding lifting guide 52, a lower end thereof is connected with a bottom sealing folding guide spring piece 53, which is “A” shaped and prevents the folded part A 2 and the folded part B 3 from being folded inwards; an outer side of the folded part A 2 and the folded part B 3 is provided with a bottom sealing folding end surface side step 54 configured for supporting the folded part A 2 and the folded part B 3; an outer side of the first side surface and the second side surface is provided with a bottom sealing side swing pressing mold block 55 configured for changing the first bottom surface 20 and the second bottom surface 21 from vertical to horizontal;
at the bottom sealing station 34, a bottom sealing part 10 is sealed by using a bottom sealing bonding head 59;
the bottom sealing part side folding station 35 folds a sealed bottom sealing part 10 sideways by 90°;
the bottom folded ear folding station 36 folds the bottom folded ear A 8 and the bottom folded ear B 9;
the bottom bonding station 37 bonds the bottom folded ear A 8 to the bottom part 5;
the bottom sealing part side bonding station 38 bonds the bottom sealing part 10 to the bottom part 5. Therefore, a reasonable arrangement of an existing assembly line is realized, and a formation of the container of the present application is also realized.

Preferably, the station connection device 50 includes a linear reciprocating mold or a circulating conveyor belt; the linear reciprocating mold or the circulating conveyor belt is provided with a station connection process opening 66; a molding mold outside the station 65 corresponding to a contour of the folded packaging body 1 is provided on the station connection process opening 66, and a pushing rod at station 51 configured for pushing the cap 4 up is provided under the station connection process opening 66; thus, exiting the mold can be achieved.

The molding mold outside the station 65 is provided with a station process concavity 67 corresponding to the second top folded ear 11 or the first upper folded ear 12. The process is reasonable, and is conducive to rapid and reasonable shaping.

At the bottom sealing station 34, an outer side of the first side surface and the second side surface is swing provided with pairs of bottom sealing bonding side pressing mold block 56, which respectively presses downwards the folded first bottom surface 20 and the folded second bottom surface 21;
the outer side of the folded part A 2 and the folded part B 3 is provided with a bottom sealing molding end surface step 57 configured for supporting the bottom folded ear A 8 and the bottom folded ear B 9; an upper part of the bottom sealing molding end surface step 57 is provided with a bottom sealing folding pressing mold 58, which is configured for pressing the bottom folded ear A 8 and the bottom folded ear B 9 located on the bottom sealing molding end surface step 57 after going down;
the bottom sealing bonding head 59 is provided with a bottom sealing bonding lifting head 60;
the bottom sealing part side folding station 35 is provided with a bottom sealing side pressing mold 61 that can swing, rotate or be lift, which is configured for folding the sealed bottom sealing part 10 sideways by 90°;
the bottom folded ear folding station 36 is provided with a bottom sealing folded ear end surface pushing mold 62 that is fixed, rotatable, retractable or can swing, which is configured for pressure contacting with the outer surface of the front surface 13; an upper part of the bottom sealing folded ear end surface pushing mold 62 is swing provided with a bottom sealing folded ear mold 63 configured for folding the corresponding bottom folded ear A 8 and the bottom folded ear B 9;
the bottom bonding station 37 is provided with a bottom sealing folded ear bonding head 64 configured for bonding the bottom folded ear A 8 and the bottom folded ear B 9 to the bottom part 5; by combing and improving the existing technologies, an effective rapid production, and safety and hygiene are achieved

A bottom folding-sealing process is configured for sealing a folded packaging container structure; the process includes the following steps. The processes shown in the drawings of the specification are not exhaustive, and reasonable changes, additions, deletions and adjustments thereto are within the protection scope of the present application.
Step 1 sealing the side sealing parts: the first side sealing part 6 and the second side sealing part 7 are sealed by using a welding machine, a bonding machine or a hot air blower;
Step 2 folding the side sealing parts: by using the mode or manual, the first side sealing part 6 is folded towards the outer side of the second side surface, and the second side sealing part 7 is folded towards the outer side of the second side surface; a folding direction of the first side sealing part 6 is the same as or opposite to that of the second side sealing part 7;
Step 3 folding the bottom sealing side: a bottom part 5 is folded along crease lines by using the mold or manual to connect the bottom sealing part 10; in particular, a joint surface of the bottom sealing part 10 is perpendicular to the joint surface of the first side sealing part 6;
Step 4 sealing the bottom sealing side: the bottom sealing part 10 is sealed by using the welding machine, the bonding machine or the hot air blower.
Step 5 folding the bottom sealing side sideways: the bottom sealing part 10 is folded sideways by using the mold or manual;
Step 6 bonding the bottom sealing side sideways: the bottom sealing part 10 is bonded to the bottom part 5 by using the welding machine, the bonding machine or the hot air blower;
after Step 5, first, a first upper folded ear 12 and a second top folded ear 11 is folded by using the mold or manual and then contacted with the bottom sealing part 10; then, bonding the bottom folded ear is performed, the first upper folded ear 12 and the second top folded ear 11 respectively are bonded to the bottom sealing part 10 by using the welding machine, the bonding machine or the hot air blower.
after Step 2, a side bonding is performed, by using the mode, the first side sealing part 6 and the outer side of the second side surface are bonded together, and the second side sealing part 7 and the outer side of the second side surface are bonded together; a bonding direction of the first side sealing part 6 and the outer side of the first side surface is the same as or opposite to that of the second side sealing part 7 and the outer side of the second side surface;
after Step 2, a filling is performed from a bottom opening to be sealed 39 of the folded packaging body 1 by using a filling machine 49;
after Step 2 or Step 1, and before Step 3, the bottom folded ear A 8 and the bottom folded ear B 9 are folded for a preforming of the bottom part, so that the crease lines of the bottom part 5 generates a crease memory.

The full description of the present application is for a clearer disclosure, and the prior art will not be enumerated.

Finally, it should be noted that, the above are the preferred embodiments of the present application, which are not intended to limit the protection scope of the present application. Therefore, all equivalent changes made according to the structure, shape and principle of the present application should be covered within the protection scope of the present application.

Listing of reference signs: 1. folded packaging body; 2. folded part A; 3. folded part B; 4. cap; 5. bottom part; 6. first side sealing part; 7. second side sealing part; 8. bottom folded ear A; 9. bottom folded ear B; 10. bottom sealing part; 11. second top folded ear; 12. first upper folded ear; 13. front surface; 14. first side surface part; 15. second side surface part; 16. first connecting part; 17. second connecting part; 18. first folded surface of bottom folded ear; 19. second folded surface of bottom folded ear; 20. first bottom surface; 21. second bottom surface; 22. first direction changing side sealing part I; 23. second direction changing side sealing part I; 24. first direction re-changing side sealing part II; 25. second direction re-changing side sealing part II; 26. first bottom sealing part I; 27. second bottom sealing part I; 28. first bottom sealing part II; 29. second bottom sealing part II; 30. adhesive strip; 31. side sealing surface folding station; 32. filling station; 33. bottom surface folding station; 34. bottom sealing station; 35. bottom sealing part side folding station; 36. bottom folded ear folding station; 37. bottom bonding station; 38. bottom sealing part side bonding station; 39. bottom opening to be sealed; 40. side folding bottom mold; 41. side folding center hole; 42. side folding outer mold; 43. side folding driving rod; 44. middle side folding concave; 45. side folding L-shape step; 46. side folding process end surface; 47. side folding pushing-up head; 48. inner forming mandrel mold; 49. filling machine; 50. station connection device; 51. pushing rod at station; 52. bottom sealing folding lifting guide; 53. bottom sealing folding guide spring piece; 54. bottom sealing folding end surface side step; 55. bottom sealing side swing pressing mold block; 56. bottom sealing bonding side pressing mold block; 57. bottom sealing molding end surface step; 58. bottom sealing folding pressing mold; 59. bottom sealing bonding head; 60. bottom sealing bonding lifting head; 61. bottom sealing side pressing mold; 62. bottom sealing folded ear end surface pushing mold; 63. bottom sealing folded ear mold; 64. bottom sealing folded ear bonding head; 65. molding mold outside the station; 66. station connection process opening; 67. station process concavity; 68. formed concavity A; 69. formed concavity B.

What is claimed is:

1. A folded packaging container structure, comprising:
a folded packaging body, forming a cavity for accommodating an object after being folded;
an upper opening, being located at an upper part of the folded packaging body;
a bottom part, facing the upper opening; and
a folded part A and a folded part B, which are folded and contacted with each other; a front surface of the folded part A and a front surface of the folded part B are provided as corresponding front surfaces of the folded packaging body and are located between the bottom part and the upper opening; at least a first side surface and a second side surface located between the bottom part and the upper opening are provided between the corresponding front surfaces;
the cavity is formed by the bottom part, the upper opening, the folded part A, the folded part B, the first side surface and the second side surface.

2. The folded packaging container structure according to claim 1, comprising at least one of following configurations:
a) a first side sealing part and a second side sealing part are provided as sealing parts of side surfaces after the folded part A and the folded part B are folded together, and a bonding direction of the first side sealing part and an outer side of the first side surface is opposite to a bonding direction of the second side sealing part and an outer side of the second side surface;
b) when the first side sealing part is bonded to an outer wall of the folded part A, the second side sealing part is bonded to an outer wall of the folded part B;
c) a root of a bottom folded ear A is connected with a lower part of the front surface of the folded part A, and there is a crease line CD at a connection part; a root of a bottom folded ear B is connected with a lower part of the front surface of the folded part B, and there is a first crease line parallel to the crease line CD at the connection part;
d) a bottom sealing part is provided as a sealing part of a bottom surface after the folded part A and the folded part B are folded; at least one of the bottom sealing part and the first side sealing part are not coplanar or the bottom sealing part and the second side sealing part are not coplanar;
e) at the first side surface, a formed concavity A is formed between an inner wall of the folded part A and the folded part B; at the second side surface, a formed concavity B that is stagger with the formed concavity A is formed between the inner wall of the folded part A and the folded part B;
f) in a direction of a projection from the first side surface to the second side surface, a joint surface of the bottom sealing part is perpendicular to at least one of a joint surface of the first side sealing part or a joint surface of the second side sealing part;
g) a cap is provided at the upper opening at least after the cavity is loaded with the object; or
h) a sealing treatment of the first side sealing part and a sealing treatment of the second side sealing part are performed simultaneously or respectively.

3. The folded packaging container structure according to claim 2, wherein, the crease line CD and the first crease line are edge lines of the bottom part;
the bottom folded ear A and a first upper folded ear are isosceles triangles or isosceles trapezoids;
the first upper folded ear is located at an upper part of the first side surface, and a second top folded ear is located at an upper part of the second side surface; when the folded packaging body is in an unfolded state, the crease line CD is perpendicular or oblique to a crease line VW at a root of the first upper folded ear or a crease line XY at a root of the second top folded ear respectively, and the first crease line is perpendicular or oblique to the crease line VW at the root of the first upper folded ear or the crease line XY at the root the second top folded ear respectively.

4. The folded packaging container structure according to claim 2, wherein, each of the folded part A and the folded part B comprises:
the front surface;
a first side surface part, wherein one side of the first side surface part is connected with one side of the front surface through a crease line WC, and the first side surface part is located at the first side surface after being folded;
a second side surface part, wherein one side of the second side surface part is connected with a second side of the front surface through a crease line YD, and the second side surface part is located at the second side surface after being folded;
a first connecting part, wherein one side of the first connecting part is connected with one side of the first side surface part;
a second connecting part, wherein one side of the second connecting part is connected with one side of the second side surface part; and wherein, the first connecting part of the folded part A and the first connecting part of the folded part B are sealingly bonded together to form the first side sealing part, and the second connecting part of the folded part A and the second connecting part of the folded part B are sealingly bonded together to form the second side sealing part;
a first folded surface of bottom folded ear, wherein the first folded surface is connected with one side waist of the bottom folded ear A through a crease line CG and is located at the bottom part after being folded;
a first bottom surface, wherein the first bottom surface is connected with the first side surface part through a crease line BC and connected with the first folded surface of bottom folded ear through a crease line CI, and is located at the bottom part after being folded; after being folded, the first folded surface of bottom folded ear is located between the bottom folded ear A and the first bottom surface;
a second folded surface of bottom folded ear, wherein the second folded surface is connected with a second side waist of the bottom folded ear A through a crease line DG and is located at the bottom part after being folded;
a second bottom surface, wherein the second bottom surface is connected with the second side surface part through a crease line DE and connected with the second folded surface of bottom folded ear through a crease line DK, and is located at the bottom part after being folded; after being folded, the second folded surface of bottom folded ear is located between the bottom folded ear A and the second bottom surface;
a first direction changing side sealing part I, wherein the first direction changing side sealing part I is connected with the first connecting part through a crease line AB and connected with the first bottom surface through a crease line BH, and is located at the bottom part after being folded; after being folded, the first direction changing side sealing part I of the folded part A and the first direction changing side sealing part I of the folded part B are bonded together to form one part of the bottom sealing part;
a second direction changing side sealing part I, wherein the second direction changing side sealing part I is connected with the second connecting part through a crease line EF and connected with the second bottom surface through a crease line EL, and is located at the bottom part after being folded; after being folded, the second direction changing side sealing part I of the folded part A and the second direction changing side sealing part I of the folded part B are bonded together to form one part of the bottom sealing part;
a first direction re-changing side sealing part II, wherein the first direction re-changing side sealing part II is connected with the first direction changing side sealing part I through a crease line GH; after being folded, the first direction re-changing side sealing part II of the folded part A and the first direction re-changing side sealing part II of the folded part B are bonded together to form a first connection part with the first side sealing part;
a second direction re-changing side sealing part II, wherein the second direction re-changing side sealing part II is connected with the second direction changing side sealing part I through a crease line LM; after being folded, the second direction re-changing side sealing part II of the folded part A and the second direction re-changing side sealing part II of the folded part B are bonded together to form a second connection part with the second side sealing part; the formed concavity A corresponds to the first connection part, and the formed concavity B corresponds to the second connection part;
a first bottom sealing part I, wherein the first bottom sealing part I is connected with the first folded surface of bottom folded ear through a crease line IG; a second bottom sealing part I, which is connected with the second folded surface of bottom folded ear through a crease line KG; the first bottom sealing part I and the second bottom sealing part I of the bottom folded ear A and the bottom folded ear B respectively are connected through a crease line GR, and contacted with each other and are sealingly bonded together;
a first bottom sealing part II, wherein the first bottom sealing part II is connected with the first bottom sealing part I through a crease line IQ, connected with the first bottom surface through a crease line HI, and connected with the first direction re-changing side sealing part II through a crease line HP; and
a second bottom sealing part II, wherein the second bottom sealing part II is connected with the second bottom sealing part I through a crease line KS, connected with the second bottom surface through a crease line KL, and connected with the second direction re-changing side sealing part II through a crease line LT; the first bottom sealing part II and the second bottom sealing part II of the bottom folded ear A and the bottom folded ear B respectively are contacted with each other and sealingly bonded together.

5. A bottom folding-sealing device for folding and sealing a bottom of the folded packaging container structure according to claim 1, comprising: at least one of following process stations:
a side sealing surface folding station, configured for at least one of folding or bonding a first side sealing part and an outer side of the first side surface, and at least one of folding or bonding a second side sealing part and an outer side of the second side surface, by using a mold; wherein a bonding direction of the first side sealing part and the outer side of the first side surface is opposite to a bonding direction of the second side sealing part and the outer side of the second side surface;
a filling station, configured for performing a filling from a bottom opening to be sealed of the folded packaging body by using a filling machine;
a bottom surface folding station, configured for folding the bottom part to form a bottom sealing part;
a bottom sealing station, configured for sealing the bottom sealing part by using a bottom sealing bonding head;
a bottom sealing part side folding station, configured for folding a sealed bottom sealing part sideways by 90°;
a bottom folded ear folding station, configured for folding a bottom folded ear A and a bottom folded ear B;
a bottom bonding station, configured for bonding the bottom folded ear A to the bottom part;
a bottom sealing part side bonding station, configured for bonding the bottom sealing part to the bottom part; and
a station connection device, provided between stations.

6. The bottom folding-sealing device according to claim 5, wherein,
the side sealing surface folding station is provided with a side folding bottom mold, on which a side folding center hole corresponding to a cap is provided; the side folding bottom mold is provided with a side folding outer mold for folding, which is connected with a side folding driving rod; the side folding outer mold is U-shaped, a middle side folding concave of the side folding outer mold corresponds to a front surface; one end of the side folding outer mold is provided with a side folding process end surface, and a second end of the side folding outer mold is provided with a side folding L-shape step;
the side folding process end surface corresponds to a lateral edge of the second side sealing part or the first side sealing part, and the side folding L-shape step corresponds to an outer surface of the first side sealing part or the second side sealing part;
an inner forming mandrel mold is inserted in the bottom opening to be sealed of the folded packaging body, and a side folding pushing-up head configured for pushing up is provided under the side folding center hole;
by using a mold, the first side sealing part and the outer side of the first side surface are bonded together, and the second side sealing part and the outer side of the second side surface are bonded together; wherein the bonding direction of the first side sealing part and the outer side of the first side surface is opposite to the bonding direction of the second side sealing part and the outer side of the second side surface;
an upper part of the bottom surface folding station is provided with a bottom sealing folding lifting guide, a lower end of the bottom surface folding station is connected with a bottom sealing folding guide spring piece, wherein the bottom sealing folding guide spring piece is “ [symbol] ” shaped to prevent the folded part A and the folded part B from being folded inwards; an outer side of the folded part A and the folded part B is provided with a bottom sealing folding end surface side step configured for supporting the folded part A and the folded part B; an outer side of the first side surface and the second side surface is provided with a bottom sealing side swing pressing mold block configured for changing a first bottom surface and a second bottom surface from vertical to horizontal.

7. The bottom folding-sealing device according to claim 5, wherein the station connection device comprises a linear reciprocating mold or a circulating conveyor belt; the linear reciprocating mold or the circulating conveyor belt is provided with a station connection process opening; a molding mold outside the station connection device corresponding to a contour of the folded packaging body is provided at the station connection process opening, and a pushing rod at the station connection device configured for pushing a cap up is provided under the station connection process opening;
the molding mold outside the station connection device is provided with a station process concavity corresponding to a second top folded ear or a first upper folded ear;
at the bottom sealing station, an outer side of the first side surface and the second side surface is provided with a pair of swingable bottom sealing bonding side pressing mold blocks, which respectively presses downwards a folded first bottom surface and a folded second bottom surface;
an outer side of the folded part A and the folded part B is provided with a bottom sealing molding end surface step configured for supporting the bottom folded ear A and the bottom folded ear B; an upper part of the bottom sealing molding end surface step is provided with a bottom sealing folding pressing mold, which is configured for pressing the bottom folded ear A and the bottom folded ear B located on the bottom sealing molding end surface step after going down;
the bottom sealing bonding head is provided with a bottom sealing bonding lifting head;
the bottom sealing part side folding station is provided with a bottom sealing side pressing mold that is configured to swing, rotate or be lifted, which is configured for folding the sealed bottom sealing part sideways by 90°;
the bottom folded ear folding station is provided with a bottom sealing folded ear end surface pushing mold that is fixed, rotatable, retractable or swingable, the bottom sealing folded ear end surface pushing mold is configured for pressure contacting with an outer surface of a front surface; an upper part of the bottom sealing folded ear end surface pushing mold is provided with a swingable bottom sealing folded ear mold configured for folding the corresponding bottom folded ear A and the bottom folded ear B;
the bottom bonding station is provided with a bottom sealing folded ear bonding head configured for bonding the bottom folded ear A and the bottom folded ear B to the bottom part.

8. A bottom folding-sealing process for folding and sealing a bottom of the folded packaging container structure according to claim 1, comprising:
Step 1, simultaneously or successively sealing both side sealing parts: respectively heating, bonding and sealing a first side sealing part and a second side sealing part;
Step 3, folding a bottom sealing side: folding the bottom part along crease lines by using a mold or manual to connect a bottom sealing part; wherein, a joint surface of the bottom sealing part is perpendicular to a joint surface of the first side sealing part; and
Step 4, sealing the bottom sealing side: heating, bonding and sealing the bottom sealing part.

9. The bottom folding-sealing process according to claim 8, wherein,
in Step 1, when sealing the first side sealing part, a first direction re-changing side sealing part II of the folded part A and a first direction re-changing side sealing part II of the folded part B are bonded together to form a first connection part with the first side sealing part;
when sealing the second side sealing part, a second direction re-changing side sealing part II of the folded part A and a second direction re-changing side sealing part II of the folded part B are bonded together to form a second connection part with the second side sealing part;
Step 2: folding the side sealing parts: when folding the side sealing part, by using a mode or manual, folding the first side sealing part towards an outer side of the second side surface, and folding the second side sealing part towards the outer side of the second side surface; wherein a folding direction of the first side sealing part is the same as or opposite to a folding direction of the second side sealing part;
before or after Step 1, the bottom folding-sealing process further comprises: folding the first side surface and the second side surface; when folding the first side surface and the second side surface, connecting one side of a first side surface part with one side of a front surface through a crease line WC such that the first side surface part is located at the first side surface after being folded; and connecting one side of a second side surface part with a second side of the front surface through a crease line YD such that the second side surface part is located at the second side surface after being folded;
Step 5: folding the bottom sealing side sideways: folding the bottom sealing part sideways by using the mold or manual;
after Step 5, the bottom folding-sealing process further comprises: folding a first upper folded ear and a second top folded ear by using a mold or manual to be contacted with the bottom sealing part; bonding a bottom folded ear; respectively bonding the first upper folded ear and the second top folded ear to the bottom sealing part by using a welding machine, a bonding machine or a hot air blower;
after Step 2, the bottom folding-sealing process further comprises: a side bonding; the side bonding comprises: by using a mode, bonding the first side sealing part and the outer side of the second side surface together, and bonding the second side sealing part and the outer side of the second side surface together; wherein a bonding direction of the first side sealing part and the outer side of the first side surface is the same as or opposite to a bonding direction of the second side sealing part and the outer side of the second side surface;
after Step 2, the bottom folding-sealing process further comprises: performing a filling from a bottom opening to be sealed of the folded packaging body by using a filling machine; and
after Step 2 or Step 1, and before Step 3, the bottom folding-sealing process further comprises: folding a bottom folded ear A and a bottom folded ear B for a preforming of the bottom part, so that the crease lines of the bottom part generate a crease memory.

10. The bottom folding-sealing process according to claim 9, wherein, in Step 3, folding the bottom sealing side comprises:
folding a first direction changing side sealing part I, a first bottom surface, a first folded surface of bottom folded ear, a second folded surface of bottom folded ear, a second bottom surface and a second direction changing side sealing part I along crease lines AB, BC, CG, DG, DE and EF respectively;
folding the first direction re-changing side sealing part II, a first bottom sealing part II, a first bottom sealing part I, a second bottom sealing part I, a second bottom sealing part II and the second direction re-changing side sealing part II along crease lines GH, HI, IG, GK, KL and LM respectively, so that the first bottom sealing part II is contacted with the second bottom sealing part II, and the first bottom sealing part I is contacted with the second bottom sealing part I;
when the first direction re-changing side sealing part II and the second direction re-changing side sealing part II are folded towards same direction, jointing a formed concavity A and a formed concavity B at both sides with each other; when the first direction re-changing side sealing part II and the second direction re-changing side sealing part II are folded towards opposite directions, jointing a protrusion formed by folding the first direction re-changing side sealing part II with the formed concavity B formed by folding the second direction re-changing side sealing part II, and jointing a protrusion formed by folding the second direction re-changing side sealing part II with the formed concavity A formed by folding the first direction re-changing side sealing part II; and
after Step 5, the bottom folding-sealing process further comprises: folding the bottom folded ear A along a crease line CD.
